(19) United States
(12) Patent Application Publication
(10) Pub. No.: US 2024/0291876 A1
(43) Pub. Date: Aug. 29, 2024

(54) CO-HOSTING SYSTEM, METHOD, APPARATUS, DEVICE AND STORAGE MEDIUM

(71) Applicant: BEIJING BYTEDANCE NETWORK TECHNOLOGY CO., LTD., Beijing (CN)

(72) Inventors: Tengyuan Cai, Beijing (CN); Yixu Wang, Beijing (CN); Xiaozhou Cao, Beijing (CN)

(21) Appl. No.: 18/569,970

(22) PCT Filed: Jun. 13, 2022
(86) PCT No.: PCT/CN2022/098396

§ 371 Date: Dec. 13, 2023

(30) Foreign Application Priority Data
Jun. 15, 2021 (CN) 202110660874.X

(51) Int. Cl. H04L 65/1108; H04L 65/403; H04L 65/65

(52) U.S. Cl. CPC H04L 65/1108; H04L 65/403; H04L 65/65

(57) ABSTRACT

The present disclosure provides a co-hosting system, method, apparatus, device, and storage medium, the system comprising: a first co-hosting terminal, a second co-hosting terminal, and a co-hosting business server; after the first co-hosting terminal sends a co-hosting application request to the second co-hosting terminal through the co-hosting business server, the second co-hosting terminal, upon receipt of a co-hosting acceptance operation for the co-hosting application request, sends a co-hosting acceptance message to the co-hosting business server, and applies to a real-time collaborative RTC server for joining a co-hosting room at the same time.

### CROSS-REFERENCE TO RELATED APPLICATION

This application claims priority of the Chinese patent application No. 202110660874.X, entitled “a co-hosting system, method, apparatus, device and storage medium”, filed on Jun. 15, 2021, which is incorporated herein in its entirety by reference.

### FIELD

The present disclosure relates to the field of data processing, and more particularly to a co-hosting system, method, apparatus, device and storage medium.

### BACKGROUND

In network livestreaming function, co-hosting has become a common form of livestreaming. Usually, the co-hosting refers to achieve real-time communication interaction between hosts or between a host and a guest in a manner similar to a video call.

Time consumption of connection establishment of the co-hosting is one of important factors affecting the user experience of the co-hosting. For example, in a scenario where a guest terminal applies to a host terminal for co-hosting, for a user of the host terminal, after clicking to agree to a guest co-hosting application, it is expected to be able to display audio-video data of the guest terminal as soon as possible.

Therefore, how to reduce the time consumption of the connection establishment of the co-hosting and improve the efficiency of the co-hosting is a technical problem that needs to be solved urgently.

### SUMMARY

To solve the above technical problems or at least partially solve the above technical problems, the present disclosure provides a co-hosting system, method, apparatus, device and storage medium.

In a first aspect, the present disclosure provides a co-hosting system, comprising a first co-hosting terminal, a second co-hosting terminal and a co-hosting business server:
the first co-hosting terminal being configured to: send a co-hosting application request to the second co-hosting terminal through the co-hosting business server:
the second co-hosting terminal being configured to: upon receipt of a co-hosting acceptance operation for the co-hosting application request, send a co-hosting acceptance message to the co-hosting business server, and apply to a real-time collaborative RTC server for joining a co-hosting room.

In an alternative embodiment, the first co-hosting terminal is further configured to: upon receipt of the co-hosting acceptance message from the co-hosting business server, apply to the RTC server for joining the co-hosting room.

In an alternative embodiment, the second co-hosting terminal is further configured to: upon receipt of the co-hosting acceptance operation for the co-hosting application request, present a countdown window.

In an alternative implementation, the second co-hosting terminal is further configured to: according to a determination that countdown of the countdown window ends, determine whether an audio-video stream pushed by the first co-hosting terminal has been received; and according to a determination that the audio-video stream has not been received, send a disconnecting co-hosting link request to the co-hosting business server and the RTC server respectively.

In an alternative embodiment, the first co-hosting terminal is further configured to: upon receipt of the co-hosting acceptance message from the co-hosting business server, present a countdown window.

In an alternative embodiment, the first co-hosting terminal is further configured to: according to a determination that countdown of the countdown window ends, push an audio-video stream to the RTC server.

In an alternative embodiment, the first co-hosting terminal comprises a guest client, and the second co-hosting terminal comprises a host client.

In a second aspect, the present disclosure provides a co-hosting method applied to a second co-hosting terminal, comprising:

receiving a co-hosting application request from a first co-hosting terminal through a co-hosting business server:
upon receipt of a co-hosting acceptance operation for the co-hosting application request, sending a co-hosting acceptance message to the co-hosting business server, and applying to a real-time collaborative RTC server for joining a co-hosting room.

In an alternative embodiment, the method further comprises: upon receipt of the co-hosting acceptance operation for the co-hosting application request, presenting a countdown window.

In an alternative embodiment, the method further comprises: according to a determination that countdown of the countdown window ends, determining whether an audio-video stream pushed by the first co-hosting terminal has been received; and according to a determination that the audio-video stream has not been received, sending a disconnecting co-hosting link request to the co-hosting business server and the RTC server, respectively.

In a third aspect, the present disclosure provides a co-hosting method applied to a first co-hosting terminal, comprising:
sending a co-hosting application request to a second co-hosting terminal through a co-hosting business server; wherein the second co-hosting terminal is configured to: upon receipt of a co-hosting acceptance operation for the co-hosting application request, send a co-hosting acceptance message to the co-hosting business server, and apply to a real-time collaborative RTC server for joining a co-hosting room:
upon receipt of the co-hosting acceptance message from the co-hosting business server, applying to the RTC server for joining the co-hosting room.

In an alternative embodiment, the method further comprises: upon receipt of the co-hosting acceptance message from the co-hosting business server, presenting a countdown window.

In an alternative embodiment, the method further comprises pushing an audio-video stream to the RTC server according to a determination that countdown of the countdown window ends.

In a fourth aspect, the present disclosure provides a co-hosting apparatus applied to a second co-hosting terminal, the apparatus comprising:
a receiving module configured to receive a co-hosting application request from a first co-hosting terminal through a co-hosting business server:
a first application module configured to: upon receipt of a co-hosting acceptance operation for the co-hosting application request, send a co-hosting acceptance message to the co-hosting business server, and apply to a real-time collaborative RTC server for joining a co-hosting room.

In a fifth aspect, the present disclosure provides a co-hosting apparatus, the apparatus comprising:
a sending module configured to send a co-hosting application request to a second co-hosting terminal through a co-hosting business server: wherein the second co-hosting terminal is configured to: upon receipt of a co-hosting acceptance operation for the co-hosting application request, send a co-hosting acceptance message to the co-hosting business server, and apply to a real-time collaborative RTC server for joining a co-hosting room:
a second application module configured to: upon receipt of the co-hosting acceptance message by the first co-hosting terminal from the co-hosting business server, apply to the RTC server for joining the co-hosting room.

In a sixth aspect, the present disclosure provides a computer-readable storage medium, the computer-readable storage medium stores instructions that, when executed on a computer device, cause the computer device to implement the method described above.

In a seventh aspect, the present disclosure provides a device comprising: a memory, a processor, and a computer program stored on the memory, the processor, when executing the computer program, implements the method described above.

In an eighth aspect, the present disclosure provides a computer program product, the computer program product comprises a computer program/instructions, the computer program/instructions, when executed by a processor, implements the method described above.

### BRIEF DESCRIPTION OF THE DRAWINGS

The accompanying drawings herein, which are incorporated into and constitute a part of the specification, illustrate the embodiments consistent with the present disclosure, and are used in connection with the specification to explain the principles of the present disclosure.

In order to more clearly illustrate the technical solutions in the embodiments of the present disclosure or in the prior art, the accompanying drawings required in the description of the embodiments or the prior art will be briefly introduced below. It is apparent to those of ordinary skill in the art that other drawings can be obtained from these accompanying drawings without any creative effort.

FIG. 1 is a schematic diagram of data interaction of co-hosting manner in current network livestreaming;

FIG. 2 is a signaling interaction diagram of a guest terminal applying to a host terminal for co-hosting provided in an embodiment of the present disclosure:

FIG. 3 is a structural schematic view of a co-hosting system provided in an embodiment of the present disclosure:

FIG. 4 is a schematic flowchart of a co-hosting method provided in an embodiment of the present disclosure:

FIG. 5 is a schematic flowchart of another co-hosting method provided in an embodiment of the present disclosure:

FIG. 6 is a structural schematic view of a co-hosting apparatus provided in an embodiment of the present disclosure:

FIG. 7 is a structural schematic view of another co-hosting apparatus provided in an embodiment of the present disclosure:

FIG. 8 is a structural schematic view of a co-hosting device provided in an embodiment of the present disclosure.

### DETAILED DESCRIPTION

In order to understand the above objectives, features, and advantages of the present disclosure more clearly, the following will further describe the solution of the present disclosure. It should be noted that, the embodiments of the present disclosure and the features in the embodiments may be combined with each other without any conflict.

Many specific details are set forth in the following description to facilitate a full understanding of the present disclosure, but the present disclosure can also be implemented in other ways different from those described herein: obviously, the embodiments in the description are only a part of the embodiments of the present disclosure, rather than all of them.

In the process of network livestreaming, real-time communication interaction is often achieved between hosts or between a host and a guest in a manner similar to a video call, also known as co-hosting.

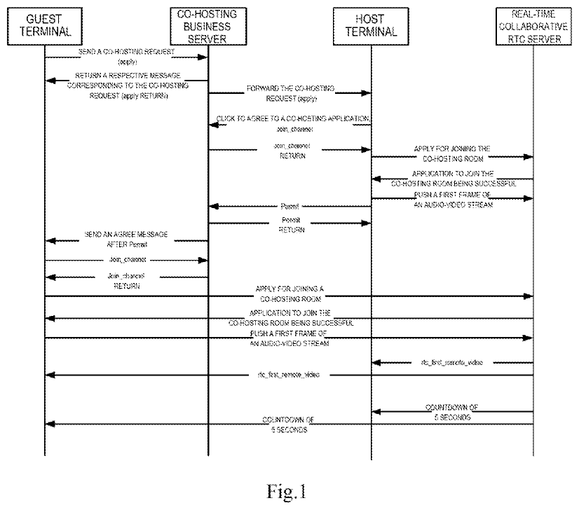

Currently, in the co-hosting manner of network livestreaming, the time consumption of the first frame of connection establishment at both ends of the co-hosting is relatively long, which affects the co-hosting experience of the user. Taking the co-hosting between host and guest as an example, as shown in FIG. 1, which is a schematic diagram of data interaction in the co-hosting manner of current network livestreaming.

Herein, a guest terminal sends a co-hosting application request, which is used for applying to a host terminal for co-hosting, to the host terminal through a co-hosting business server. Assuming that the user of the host terminal triggers a co-hosting acceptance operation for the co-hosting application request from the guest terminal, the host terminal sends a Join_channel request to the co-hosting business server for requesting for joining the co-hosting room to the co-hosting business server. If the host terminal receives a Join_channel return message from the co-hosting business server, the host terminal can apply to the real-time collaborative (Real-Time Communications: RTC) server for joining the co-hosting room. After receiving a notification message of successfully joining the co-hosting room returned by the RTC server, the host terminal sends a co-hosting acceptance message (permit) to the co-hosting business server to notify the co-hosting business server that the co-hosting application has been accepted. The co-hosting business server forwards the permit message to the guest terminal, and the guest terminal knows that the host terminal accepts the co-hosting application at this time.

In fact, the host terminal first sends a Join_channel request to the co-hosting business server after receiving the co-hosting acceptance operation for the co-hosting application request, and applies for joining the co-hosting room to the RTC server after receiving the Join_channel return message returned by the co-hosting business server, and can send a permit message to the co-hosting business server to notify the guest terminal applying for co-hosting a message that the peer has accepted the co-hosting application only after successfully joining the co-hosting room. At this time, the guest terminal starts to apply to the RTC server for joining the co-hosting room, and starts to push an audio-video stream to the RTC server after successfully joining the co-hosting room.

After the guest terminal receives the message that the host terminal accepts the co-hosting application, the guest terminal sends a Join_channel request to the co-hosting business server to request permission from the co-hosting business server for joining the co-hosting room. After the guest terminal receives the Join_channel return message from the co-hosting business server, the guest terminal can apply to the RTC server for joining the co-hosting room. After receiving the notification message of successfully joining the co-hosting room returned by the RTC server, it starts pushing the audio-video stream to the RTC server.

In summary; the time consumption taken by the second co-hosting terminal that accepts the co-hosting from the co-hosting acceptance operation to receiving the first frame picture of the first co-hosting terminal is one of the factors affecting co-hosting efficiency. The time consumption taken by the first co-hosting terminal that initiates the co-hosting application from receiving the co-hosting acceptance message of the second co-hosting terminal to receiving the first frame picture of the peer is also one of the factors affecting co-hosting efficiency. Therefore, the inventor proposes an optimization scheme for co-hosting based on this.

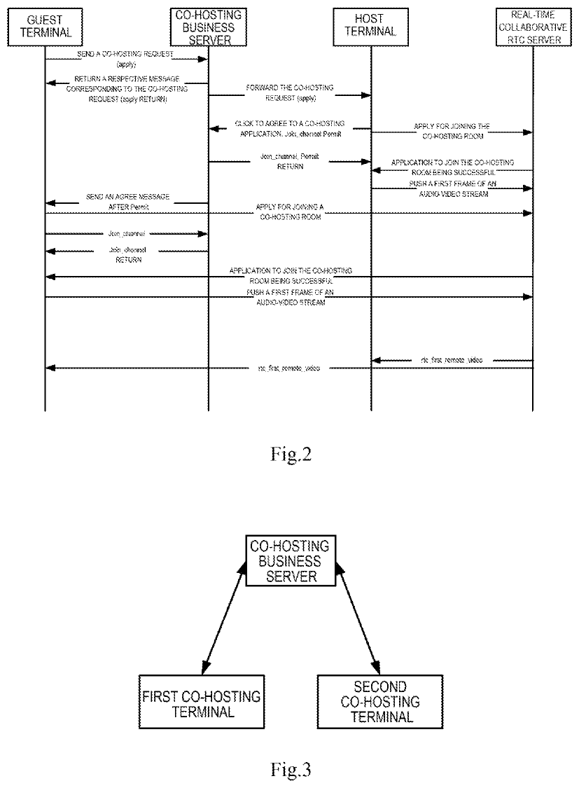

As shown in FIG. 2, which is a signaling interaction diagram of a guest terminal applying to a host terminal for co-hosting provided in an embodiment of the present disclosure. Here, upon receipt of the co-hosting acceptance operation for the co-hosting application request, the host terminal sends a Join_channel request to the co-hosting business server, sends a co-hosting acceptance message (permit) to the co-hosting business server, and applies for joining the co-hosting room to the real-time collaborative RTC server without waiting for the co-hosting business server to return Join_channel return message before applying to the RTC server for joining the co-hosting room.

Since the host terminal advances the timing of applying to the RTC server for joining the co-hosting room, that is, it can apply to the RTC server for joining the co-hosting room upon receipt of the co-hosting acceptance operation, so that the host terminal can enter the co-hosting room in advance. In addition, due to the fact that the host terminal advances the timing of sending the co-hosting acceptance message to the co-hosting business server, that is, it can send a permit message to the co-hosting business server upon receipt of the co-hosting acceptance operation, so that the guest terminal can receive the permit message forwarded by the co-hosting business server in advance. Therefore, the guest terminal can apply to the RTC server for joining the co-hosting room in advance, and start pushing the audio-video stream to the RTC server in advance, so that the host terminal can pull the audio-video stream of the guest terminal in advance and start confluence in advance. Accordingly, embodiments of the present disclosure shorten the time consumption taken by the host terminal from the co-hosting acceptance operation to receiving the first frame picture of the guest terminal, improving co-hosting efficiency, and also enhancing the co-hosting experience of the user of the host terminal.

In addition, since the host terminal advances the timing of sending a co-hosting acceptance message (permit) to the co-hosting business server, the guest terminal can receive the permit message forwarded by the co-hosting business server to the guest terminal in advance, that is, the guest terminal can receive the message that the host terminal accepts the co-hosting application in advance. After receiving the permit message, the guest terminal can apply to the RTC server for joining the co-hosting room without need of waiting for the return message of the co-hosting business server for the sent Join_channel request, and pull the audio-video stream of the peer in advance. This shortens the time consumption of the first frame of co-hosting on the guest terminal, improving the efficiency of co-hosting, and also enhancing the co-hosting experience of guest terminal users.

Based on this, the present disclosure provides a co-hosting system, referring to FIG. 3, which is a structural schematic view of a co-hosting system provided in an embodiment of the present disclosure, wherein the co-hosting system comprises a first co-hosting terminal 301, a second co-hosting terminal 302 and co-hosting business server 303.

The first co-hosting terminal 301 is configured to send a co-hosting application request to the second co-hosting terminal through the co-hosting business server.

In the embodiments of the present disclosure, the co-hosting business server is communicatively connected to the first co-hosting terminal and the second co-hosting terminal respectively. The first co-hosting terminal sends the co-hosting application request to the second co-hosting terminal through the co-hosting business server, and the second co-hosting terminal accepts the co-hosting application request from the first co-hosting terminal through the co-hosting business server. Here, the co-hosting application request is used for requesting the second co-hosting terminal to accept the co-hosting application of the first co-hosting terminal.

In practical application, the first co-hosting terminal sends the co-hosting application request to the co-hosting business server to request that the second co-hosting terminal accepts the co-hosting application, and the co-hosting business server returns a response message to the first co-hosting terminal after receiving the co-hosting application to notify the first co-hosting terminal that the co-hosting application request has been successfully received.

In an alternative embodiment, the first co-hosting terminal comprises a guest client, the second co-hosting terminal comprises a host client. The guest client sends the co-hosting application request to the host client through the co-hosting business server, and the host client accepts the co-hosting application request from the guest client through the co-hosting business server.

The second co-hosting terminal 302 is configured to: upon receipt of a co-hosting acceptance operation for the co-hosting application request, send a co-hosting acceptance message to the co-hosting business server, and apply to a real-time collaborative RTC server for joining a co-hosting room.

In the embodiments of the present disclosure, the co-hosting acceptance message is used for notifying the co-hosting business server that the second co-hosting terminal has accepted the co-hosting application of the first co-hosting terminal.

In the embodiments of the present disclosure, after the first co-hosting terminal sends the co-hosting application request to the co-hosting business server, the co-hosting business server sends a return message for the co-hosting application request to notify that the co-hosting application request has been successfully received. The co-hosting business server forwards the co-hosting application request to the second co-hosting terminal, and when the second co-hosting terminal receives the co-hosting acceptance operation for the co-hosting application request, the second co-hosting terminal sends a co-hosting acceptance message to the co-hosting business server, and applies to the real-time collaborative RTC server for joining the co-hosting room. For example, the second co-hosting terminal, upon receipt of the co-hosting acceptance operation for the co-hosting application request sent by the first co-hosting terminal, sends a permit message to the co-hosting business server, to notify the co-hosting business server that the co-hosting application from the first co-hosting terminal has been accepted, while sending a rtc_join_channel message to the RTC server, to apply to the RTC server for joining the co-hosting room.

In the embodiments of the present disclosure, when the second co-hosting terminal receives the co-hosting application request forwarded by the co-hosting business server from the first co-hosting terminal, the co-hosting acceptance operation for the co-hosting application request can be triggered in any way. For example, a prompt message (such as “XXX is requesting for co-hosting, do you agree”) pops up on a screen of a device (such as a mobile phone, computer, tablet, etc.) used by the user of the second co-hosting terminal for co-hosting. If the user of the second co-hosting terminal clicks “agree”, the second co-hosting terminal receives the co-hosting acceptance operation for the co-hosting application request.

In an alternative embodiment, when the second co-hosting terminal receives the co-hosting acceptance operation for the co-hosting application request, the co-hosting acceptance message sent to the co-hosting business server can be processed in parallel, that is, the second co-hosting terminal advances the timing of sending the co-hosting acceptance message to the co-hosting business server, so that the first co-hosting terminal can receive the co-hosting acceptance message from the second co-hosting terminal in advance. Thus, the time consumption for the user of the first co-hosting terminal to know whether the peer user agrees to the co-hosting application request is shortened.

In addition, when the second co-hosting terminal receives the co-hosting acceptance operation for the co-hosting application request, it does not need to wait for the return message of the co-hosting business server for the Join_channel message, and can apply to the real-time collaborative RTC server for joining the co-hosting room, that is, the timing of applying for joining the co-hosting room is advanced. Thus, the time consumption of the user of the second co-hosting terminal from accepting the co-hosting application to receiving the first frame picture of the co-hosting terminal is shortened, improving the co-hosting efficiency, and enhancing the co-hosting experience of the co-hosting acceptance applicant.

In the embodiments of the present disclosure, after the real-time collaborative RTC server returns a message of application to join the co-hosting room being successful to the second co-hosting terminal, the second co-hosting terminal pushes the audio-video stream to the real-time collaborative RTC server. When the first co-hosting terminal receives the co-hosting acceptance message forwarded by the co-hosting business server from the second co-hosting terminal, it starts a subsequent RTC room-entering process and pushes the audio-video stream until it receives the first frame picture of the peer, realizing co-hosting between the first co-hosting terminal and the second co-hosting terminal.

In the co-hosting system provided in an embodiment of the present disclosure, after the first co-hosting terminal sends the co-hosting application request to the second co-hosting terminal through the co-hosting business server, the second co-hosting terminal, upon receipt of the co-hosting acceptance operation for the co-hosting application request, sends the co-hosting acceptance message to the co-hosting business server, and applies to the real-time collaborative RTC server for joining the co-hosting room at the same time. Since the second co-hosting terminal, upon receipt of the co-hosting acceptance operation for the co-hosting application request, advances the timing of sending the co-hosting acceptance message to the co-hosting business server and applying to the real-time collaborative RTC server for joining the co-hosting room, the time consumption taken by the second co-hosting terminal that accepts the co-hosting from the co-hosting acceptance operation to receiving the first frame picture of the first co-hosting terminal, improving the efficiency of co-hosting, and also enhancing the co-hosting experience of the user of the second co-hosting terminal who accepts co-hosting.

As shown in FIG. 1, the host terminal (i.e., the second co-hosting terminal) first sends a Join_channel request to the co-hosting business server after agreeing to the co-hosting application request from the guest terminal (i.e., the first co-hosting terminal), and after receiving the Join_channel return message returned by the co-hosting business server, applies to the RTC server for joining the co-hosting room. After successfully joining the co-hosting room, the host terminal pushes the audio-video stream to the RTC server and sends a permit message to the co-hosting business server to notify the guest terminal applying for co-hosting a message that the peer has accepted the co-hosting application. At this time, the guest terminal starts to apply to the RTC server for joining the co-hosting room, and starts to push an audio-video stream to the RTC server after successfully joining the co-hosting room. At this time, the host terminal pulls the audio-video stream of the guest terminal and starts the confluence.

As shown in FIG. 1, after the host terminal receives the first frame from the guest terminal, it needs to wait the countdown time of another 5 seconds to remove a countdown mask layer and truly achieve the co-hosting of both parties. Therefore, even if the host terminal receives the first frame picture from the guest terminal, it still needs to wait for a period of time to truly achieve co-hosting, which reduces the efficiency of co-hosting and the co-hosting experience of the user.

In order to enhance the co-hosting efficiency, the timing of presenting the countdown window by the second co-hosting terminal can be advanced to reduce unnecessary waiting time for both co-hosting parties.

In an alternative embodiment, the second co-hosting terminal is further configured to, upon receipt of the co-hosting acceptance operation for the co-hosting application request, present the countdown window.

In the embodiments of the present disclosure, the second co-hosting terminal, upon receipt of the co-hosting acceptance operation for the co-hosting application request, may present the countdown window: That is to say, when the second co-hosting terminal receives the co-hosting acceptance operation for the co-hosting application request, the countdown window mask layer begins to be displayed on a user display interface of the second co-hosting terminal, and when the countdown ends, the first frame picture of the peer can be started to be rendered. The embodiments of the present disclosure shorten the time consumption of the first frame by advancing the timing of the countdown, enhancing the co-hosting efficiency, and thus improving the co-hosting experience of the user of the second co-hosting terminal.

After the host terminal receives the first frame picture from the guest terminal, not only does the host terminal need to present a countdown window; but also the guest terminal needs to present a countdown window. As shown in FIG. 1, after receiving the co-hosting acceptance message (permit) forwarded by the co-hosting business server, the guest terminal (i.e., the first co-hosting terminal) sends a Join_channel request to the co-hosting business server, and the co-hosting business server sends a Join_channel return message for the Join_channel request to notify the guest terminal whether to agree to join the co-hosting room. Then, the guest terminal applies to the RTC server for joining the co-hosting room. After the RTC server returns a notification message of successfully joining the co-hosting room, the guest terminal pushes the audio-video stream to the RTC server. After the host terminal pulls the audio-video stream of the guest terminal (i.e., the second co-hosting terminal), the confluence is started. After the host terminal receives the first frame from the guest terminal, it needs to wait for the countdown time of another 5 seconds to remove the countdown mask layer and truly achieve co-hosting of both parties. In other words, even if the guest terminal has received the first frame picture from the host terminal, it still needs to wait for a period of time to remove the countdown mask layer, truly achieving co-hosting with the host terminal, which reduces the efficiency of co-hosting and the co-hosting experience of the user of the guest terminal is not good. Therefore, in order to improve co-hosting efficiency, the timing of the countdown window presented by the first co-hosting terminal can be advanced to reduce unnecessary waiting time for both co-hosting parties.

In an alternative embodiment, the first co-hosting terminal is also configured to present a countdown window upon receipt of a co-hosting acceptance message from the co-hosting business server.

In the embodiments of the present disclosure, the first co-hosting terminal directly presents the countdown window after receiving the co-hosting acceptance message forwarded from the co-hosting business server, that is, the countdown window mask layer is displayed on the display screen of the first co-hosting terminal at this time. As shown in FIG. 2, the guest terminal (i.e., the first co-hosting terminal) directly presents the countdown window after receiving the co-hosting acceptance message (permit) forwarded from the co-hosting business server. During the countdown process, the guest terminal also applies to the RTC server for joining the co-hosting room. In the embodiments of the present disclosure, the first co-hosting terminal advances the timing of presenting the countdown window; so that the first co-hosting terminal does not need to wait for extra countdown time after receiving the first frame picture of the second co-hosting terminal, shortening the time consumption of the first frame, improving the overall co-hosting efficiency, and thus enhancing the co-hosting experience of the user of the first co-hosting terminal.

The second co-hosting terminal, upon receipt of the co-hosting acceptance operation for the co-hosting application request, not only sends a co-hosting acceptance message to the co-hosting business server, but also applies to the real-time collaborative RTC server for joining the co-hosting room. That is to say, when applying to the RTC server for joining the co-hosting room, the Join_channel return message from the co-hosting business server has not been received. The second co-hosting terminal does not know whether the co-hosting business server agrees to join the co-hosting room. If the co-hosting business server does not agree the second co-hosting server to join the co-hosting room for some reason, and the second co-hosting terminal has already applied to the RTC server for joining the co-hosting room, an error may occur and the co-hosting user experience is reduced. In order to avoid the occurrence of the above situation, the embodiments of the present disclosure add an error handling step so that the second co-hosting terminal can disconnect from other communication terminals in a timely manner when certain steps fail.

In an alternative implementation, the second co-hosting terminal is further configured to: according to a determination that countdown of the countdown window ends, determine whether the audio-video stream pushed by the first co-hosting terminal has been received, and according to a determination that the audio-video stream has not been received, send a disconnecting co-hosting link request to the co-hosting business server and the RTC server respectively.

In the embodiments of the present disclosure, the second co-hosting terminal, upon receipt of the co-hosting acceptance operation for the co-hosting application request, applies to the real-time collaborative RTC server for joining the co-hosting room and directly presents the countdown window. At this time, the second co-hosting terminal has applied to join the co-hosting room and started pushing the audio-video stream to the real-time collaborative RTC server. During the countdown of the second co-hosting terminal, if the second co-hosting terminal has successfully joined the co-hosting room, it needs to wait to pull the audio-video stream pushed by the first co-hosting terminal. Therefore, the second co-hosting terminal, according to a determination that the countdown of the countdown window ends, needs to determine whether the audio-video stream pushed by the first co-hosting terminal has been received, so that the second co-hosting terminal can present the first frame picture of the peer when the countdown ends.

Specifically, when the countdown of the countdown window ends, if the second co-hosting terminal determines that it has received the audio-video stream pushed by the first co-hosting terminal, the countdown mask layer is removed, and the first frame picture of the first co-hosting terminal is presented on the display screen of the second co-hosting terminal to achieve co-hosting with the first co-hosting terminal. When the countdown of the countdown window of the second co-hosting terminal ends, some tasks performed by the second co-hosting terminal may have errors. For example, if there is an error in sending the co-hosting acceptance message to the co-hosting business server or an error in applying to the real-time collaborative RTC server for joining the co-hosting room, the second co-hosting terminal cannot receive the audio-video stream pushed by the first co-hosting terminal. At this time, the second co-hosting terminal can send a disconnecting co-hosting link request to the co-hosting business server and the RTC server, respectively. After receiving the disconnecting co-hosting link request, the co-hosting business server forwards the disconnecting co-hosting link request to the first co-hosting terminal. The first co-hosting terminal disconnects the connection with the first co-hosting terminal after receiving the disconnecting co-hosting link request. This not only improves the efficiency of co-hosting, but also improves the stability of co-hosting.

As shown in FIG. 1, the guest terminal (i.e., the first co-hosting terminal) sends a Join_channel request to the co-hosting business server after receiving the co-hosting acceptance message (permit) forwarded by the co-hosting business server, which is used for requesting the co-hosting business server to agree to join the co-hosting room. The co-hosting business server sends a Join_channel return message in response to the Join_channel request to notify the guest terminal whether to agree it to join the co-hosting room. Assuming the Join_channel return message indicates that the co-hosting business server agrees the guest terminal to join the co-hosting room, the guest terminal can apply to the RTC server for joining the co-hosting room. After receiving the message of successfully joining the co-hosting room returned by the RTC server, the guest terminal starts pushing audio-video stream to the RTC server.

In order to enhance the efficiency of co-hosting, the guest terminal can advance the timing of applying to the RTC server for joining the co-hosting room, in order to shorten the time consumption of the first frame of the co-hosting on the guest terminal.

In an alternative embodiment, the first co-hosting terminal is further configured to: upon receipt of a co-hosting acceptance message from the co-hosting business server, apply to the RTC server for joining the co-hosting room.

In the embodiments of the present disclosure, the first co-hosting terminal sends a co-hosting application request to the second co-hosting terminal through the co-hosting business server, waits for the second co-hosting terminal to return a co-hosting acceptance message through the co-hosting business server, and applies to the RTC server for joining the co-hosting room. As shown in FIG. 2, the guest terminal (i.e., the first co-hosting terminal) directly applies to the real-time collaborative RTC server for joining the co-hosting room after receiving the co-hosting acceptance message (permit) forwarded from the co-hosting business server, without prioritizing the execution of sending the Join_channel request to the co-hosting business server, and without waiting for the co-hosting business server to return Join_channel return message for the Join_channel request. The first co-hosting terminal in the embodiments of the present disclosure advances the timing of applying for joining the co-hosting room, shortens the time consumption of co-hosting connection establishment of the first co-hosting terminal from receiving the co-hosting acceptance message forwarded from the co-hosting business server to receiving the first frame of the peer, thereby improving the overall co-hosting efficiency.

As shown in FIG. 1, after the guest terminal pulls the first frame of the host terminal (i.e., the second co-hosting terminal), it needs to wait another 5 seconds for the countdown and the mask layer can be only removed after the countdown ends. That is, the user of the guest terminal can only see the co-hosting picture of the user of the host terminal after the countdown ends. Obviously, the time consumption of the connection establishment of the guest terminal from receiving the co-hosting acceptance message forwarded by the co-hosting business server to receiving the first frame of the peer is also one of the factors affecting the efficiency of co-hosting. Since the guest terminal may have successfully pushed the audio-video stream to the RTC server while waiting for the countdown, the host terminal can receive the first frame picture of the guest terminal in advance and present it. However, at this time, the user of the guest terminal is not aware that its dynamics have been displayed on the host terminal, which poses a privacy data security risk for the user of the guest terminal. In summary; the inventor proposes a further optimization plan for co-hosting based on this.

In an alternative embodiment, the first co-hosting terminal is further configured to: according to a determination that countdown of the countdown window ends, push an audio-video stream to the RTC server.

In the embodiments of the present disclosure, the first co-hosting terminal, upon receipt of the co-hosting acceptance message forwarded from the co-hosting business server, presents a countdown window; and according to a determination that the countdown of the countdown window ends, starts pushing the audio-video stream to the RTC server. Therefore, the first co-hosting terminal is prevented from pushing the audio-video stream to the RTC server during the countdown period. Since the first co-hosting terminal only pushes the audio-video stream to the RTC server after determining that the countdown of the countdown window ends, the RTC server will not receive the audio-video stream from the first co-hosting terminal before the countdown ends, and the second co-hosting terminal cannot pull the audio-video stream of the first co-hosting terminal from the RTC server. Therefore, the display screen of the second co-hosting terminal does not display the relevant pictures of the user of the first co-hosting terminal in advance, which improves the co-hosting security of the first co-hosting terminal and enhances the user co-hosting experience.

In the co-hosting system provided in embodiments of the present disclosure, the first co-hosting terminal, upon receipt of a co-hosting acceptance message from the co-hosting business server, applies to the RTC server for joining the co-hosting room, presents a countdown window at the same time, and pushes an audio-video stream to the RTC server according to a determination that the countdown of the countdown window ends. Since the first co-hosting terminal receives a co-hosting acceptance message from the co-hosting business server, it advances the timing of presenting the countdown window and applying for joining the co-hosting room. Therefore, the time consumption of the first co-hosting terminal from receiving the co-hosting acceptance message to receiving the first frame picture of the second co-hosting terminal is shortened, and the efficiency of co-hosting is improved.

In addition, since the first co-hosting terminal pushes the audio-video stream to the RTC server only after determining that the countdown ends, it ensures that during the countdown period of the first co-hosting terminal, relevant pictures of the first co-hosting terminal are not presented in the second co-hosting terminal, improving the co-hosting security of the first co-hosting terminal and enhancing the user co-hosting experience.

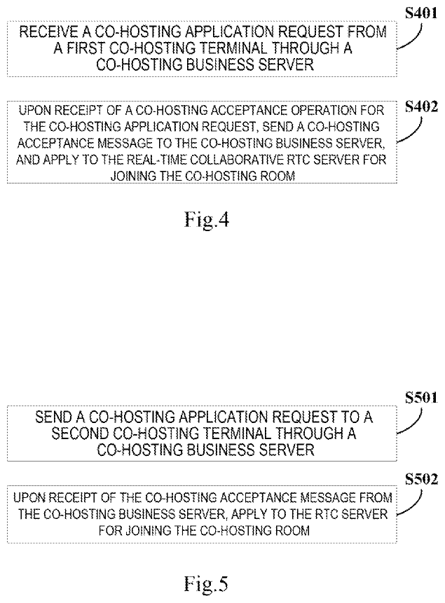

Based on the above system embodiments, the present disclosure also provides a co-hosting method applied to the second co-hosting terminal. Referring to FIG. 4, which is a flowchart of a co-hosting method provided in an embodiment of the present disclosure embodiment, the method comprises:

S401: receiving a co-hosting application request from a first co-hosting terminal through a co-hosting business server.

In the embodiments of the present disclosure, the co-hosting business server is communicatively connected to the first co-hosting terminal and the second co-hosting terminal respectively, and the second co-hosting terminal accepts the co-hosting application request from the first co-hosting terminal through the co-hosting business server. Here, the co-hosting application request is used for requesting the second co-hosting terminal to accept the co-hosting application of the first co-hosting terminal.

S402: upon receipt of a co-hosting acceptance operation for the co-hosting application request, sending a co-hosting acceptance message to the co-hosting business server, and applying to the real-time collaborative RTC server for joining the co-hosting room.

In the embodiments of the present disclosure, the co-hosting acceptance message is used for notifying the co-hosting business server that the second co-hosting terminal has accepted the co-hosting application of the first co-hosting terminal.

In the embodiments of the present disclosure, the second co-hosting terminal, upon receipt of the co-hosting acceptance operation for the co-hosting application request, sends the co-hosting acceptance message to the co-hosting business server, and applies to the real-time collaborative RTC server for joining the co-hosting room.

In the embodiments of the present disclosure, the second co-hosting terminal, upon receipt of the co-hosting acceptance operation for the co-hosting application request, advances the timing of sending the co-hosting acceptance message to the co-hosting business server, so that the first co-hosting terminal can receive the co-hosting acceptance message from the second co-hosting terminal in advance. Thus, the time consumption required for the first co-hosting terminal to know whether the peer has agreed to the co-hosting application request is shortened. Furthermore, the second co-hosting terminal, upon receipt of the co-hosting acceptance operation for the co-hosting application request, without need of waiting for the co-hosting business server to return a message for the Join_channel message, can apply to the RTC server for joining the co-hosting room, i.e., advance the timing of applying for joining the co-hosting room, shortening the time consumption of the second co-hosting terminal which accepts the co-hosting from the co-hosting acceptance operation to receiving the first frame picture from the first co-hosting terminal, improving the co-hosting efficiency.

In an alternative embodiment, the method further comprises: upon receipt of the co-hosting acceptance operation for the co-hosting application request, present the countdown window:

In an alternative embodiment, the method further comprises: according to a determination that countdown of the countdown window ends, determining whether an audio-video stream pushed by the first co-hosting terminal has been received; and according to a determination that the audio-video stream has not been received, sending a disconnecting co-hosting link request to the co-hosting business server and the RTC server, respectively.

In the co-hosting method provided in an embodiment of the present disclosure, after the first co-hosting terminal sends the co-hosting application request to the second co-hosting terminal through the co-hosting business server, the second co-hosting terminal, upon receipt of the co-hosting acceptance operation for the co-hosting application request, sends the co-hosting acceptance message to the co-hosting business server, and applies to the real-time collaborative RTC server for joining the co-hosting room at the same time. Since the second co-hosting terminal, upon receipt of the co-hosting acceptance operation for the co-hosting application request, advances the timing of sending the co-hosting acceptance message to the co-hosting business server and applying to the real-time collaborative RTC server for joining the co-hosting room, the time consumption taken by the second co-hosting terminal that accepts the co-hosting from the co-hosting acceptance operation to receiving the first frame picture of the first co-hosting terminal, improving the efficiency of co-hosting, and also enhancing the co-hosting experience of the user of the second co-hosting terminal who accepts co-hosting.

Based on the above embodiments of the system, the present disclosure also provides another co-hosting method, applied to the first co-hosting terminal. Referring to FIG. 5, which is a flowchart of another co-hosting method provided in an embodiment of the present disclosure embodiment, the method comprises:

S501: sending a co-hosting application request to a second co-hosting terminal through a co-hosting business server.

Here, the second co-hosting terminal is configured to: upon receipt of a co-hosting acceptance operation for the co-hosting application request, send a co-hosting acceptance message to the co-hosting business server, and apply to a real-time collaborative RTC server for joining a co-hosting room.

In the embodiments of the present disclosure, the co-hosting business server is communicatively connected to the first co-hosting terminal and the second co-hosting terminal respectively, and the first co-hosting terminal sends a co-hosting application request to the second co-hosting terminal through the co-hosting business server. Here, the co-hosting application request is used for requesting the second co-hosting terminal to accept the co-hosting application of the first co-hosting terminal.

S502: Upon receipt of the co-hosting acceptance message from the co-hosting business server, applying to the RTC server for joining the co-hosting room.

In the embodiments of the present disclosure, the co-hosting acceptance message is used for notifying the co-hosting business server that the second co-hosting terminal has accepted the co-hosting application of the first co-hosting terminal.

In the embodiments of the present disclosure, the first co-hosting terminal sends a co-hosting application request to the second co-hosting terminal through the co-hosting business server, waits for the second co-hosting terminal to return a co-hosting acceptance message through the co-hosting business server, and applies to the RTC server for joining the co-hosting room. The first co-hosting terminal, upon receipt of a co-hosting acceptance message from the co-hosting business server, directly applies to the RTC server for joining the co-hosting room without prioritizing the execution of sending a Join_channel request to the co-hosting business server, and without waiting for the co-hosting business server to return a message for the Join_channel request. The first co-hosting terminal in the embodiments of the present disclosure advances the timing of applying for joining the co-hosting room and pulls the audio-video stream of the peer in advance, thereby shortening the time consumption of co-hosting connection establishment of the first co-hosting terminal from receiving the co-hosting acceptance message forwarded from the co-hosting business server to receiving the first frame of the peer, thereby improving the overall co-hosting efficiency.

In an alternative embodiment, the method further comprises: upon receipt of the co-hosting acceptance message from the co-hosting business server, presenting the countdown window.

In an alternative embodiment, the method further comprises: according to a determination that the countdown of the countdown window ends, pushing the audio-video stream to the RTC server.

In the co-hosting method provided in an embodiment of the present disclosure, the first co-hosting terminal, upon receipt of a co-hosting acceptance message from the co-hosting business server, applies to the RTC server for joining the co-hosting room. Since the first co-hosting terminal advances the timing of applying for joining the co-hosting room upon receipt of the co-hosting acceptance message from the co-hosting business server, the time consumption of the co-hosting connection establishment of the first co-hosting terminal which initiates the co-hosting from receiving the co-hosting acceptance message to receiving the first frame of the peer is shortened, which improves the efficiency of co-hosting and enhances the co-hosting experience of users.

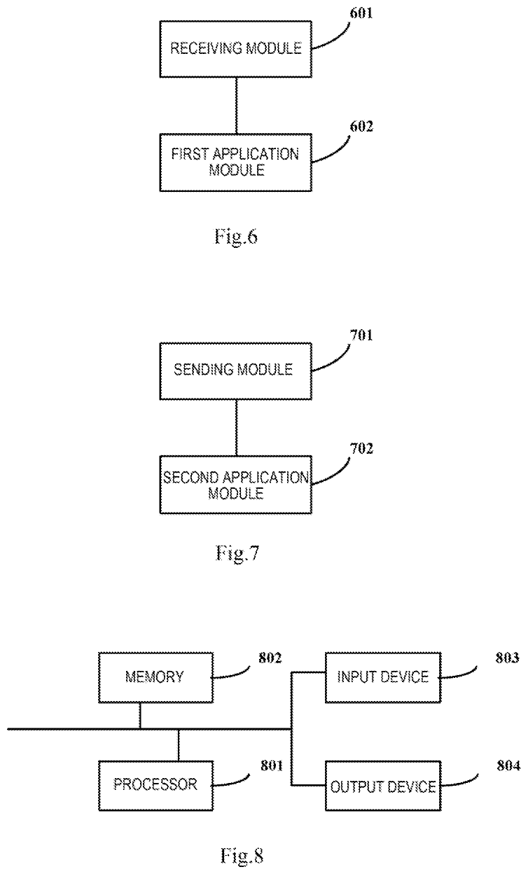

Based on the same inventive concept as the above method embodiments, the present disclosure also provides a co-hosting apparatus applied to a second co-hosting terminal. Referring to FIG. 6, which is a structural schematic view of a co-hosting apparatus provided in an embodiment of the present disclosure, the apparatus comprises:
a receiving module 601, configured to receive a co-hosting application request from a first co-hosting terminal through a co-hosting business server:
a first application module 602, configured to: upon receipt of a co-hosting acceptance operation for the co-hosting application request, send a co-hosting acceptance message to the co-hosting business server, and apply to a real-time collaborative RTC server for joining a co-hosting room.

In an alternative embodiment, the apparatus further comprises:
a first presentation module, configured to: upon receipt of the co-hosting acceptance operation for the co-hosting application request, present a countdown window.

In an alternative embodiment, the apparatus further comprises:
a disconnection module configured to: according to a determination that countdown of the countdown window ends, determining whether an audio-video stream pushed by the first co-hosting terminal has been received; and according to a determination that the audio-video stream has not been received, sending a disconnecting co-hosting link request to the co-hosting business server and the RTC server, respectively.

Based on the same inventive concept as the above method embodiments, the present disclosure also provides a co-hosting apparatus, referring to FIG. 7, which a structural schematic view of another co-hosting apparatus provided in an embodiment of the present disclosure, the apparatus comprises:
a sending module 701 is configured to send a co-hosting application request to a second co-hosting terminal through a co-hosting business server: wherein the second co-hosting terminal is configured to: upon receipt of a co-hosting acceptance operation for the co-hosting application request, return a co-hosting acceptance message to the co-hosting business server, and apply to a real-time collaborative RTC server for joining a co-hosting room:
a second application module 702 configured to: upon receipt of the co-hosting acceptance message by the first co-hosting terminal from the co-hosting business server, apply to the RTC server for joining the co-hosting room.

In an alternative embodiment, the apparatus further comprises:
a second present module configured to present a countdown window when the first co-hosting terminal receives the co-hosting acceptance message from the co-hosting business server.

In an alternative embodiment, the apparatus further comprises:
a push module configured to push the audio-video stream by the first co-hosting terminal to the RTC server according to a determination that the countdown of the countdown window ends.

In the co-hosting apparatus provided in an embodiment of the present disclosure, since the second co-hosting terminal, upon receipt of the co-hosting acceptance operation for the co-hosting application request, advances the timing of sending the co-hosting acceptance message to the co-hosting business server and applying to the real-time collaborative RTC server for joining the co-hosting room, the time consumption taken by the second co-hosting terminal that accepts the co-hosting from the co-hosting acceptance operation to receiving the first frame picture of the first co-hosting terminal. Furthermore, since the first co-hosting terminal advances the timing of applying for joining the co-hosting room upon receipt of the co-hosting acceptance message from the co-hosting business server, the time consumption of the first co-hosting terminal from receiving the co-hosting acceptance message to presenting the first frame picture on the second co-hosting terminal is shortened, improving the efficiency of co-hosting, and enhancing the co-hosting experience of the user.

In addition to the above-described method and apparatus, the present disclosure further provides a computer-readable storage medium, the computer-readable storage medium stores instructions, when executed on a terminal device, cause the terminal device to implement the co-hosting method of the embodiments of the present disclosures.

Furthermore, the present disclosure further provides a co-hosting device, as shown in FIG. 8, may comprise:

A processor 801, a memory 802, an input device 803 and an output device 804. The number of the processor 801 in the co-hosting device may be one or more, and one processor in FIG. 8 is used as an example. In some embodiments of the present disclosure, the processor 801, the memory 802, the input device 803 and the output device 804 may be connected via a bus or other means, wherein the connection via a bus in FIG. 8 is used as an example.

The memory 802 may be used for storing software programs and modules, and the processor 801 executes various functional applications of the co-hosting device and data processing by running the software programs and modules stored in the memory 802. The memory 802 may mainly comprise a storage program area and a storage data area, wherein the storage program area may store an operating system, an application program required for at least one function, etc. In addition, the memory 802 may comprise high-speed random access memory and may also comprise non-volatile memory, such as at least one disk storage device, a flash memory device, or other volatile solid-state storage devices. The input device 803 may be used for receiving input digital or character information, and generate signal inputs related to user settings and functional control of the co-hosting device.

Specifically, in this embodiment, the processor 801 will load an executable file corresponding to the process of one or more application programs into the memory 802 according to the following instructions, and run the application stored in the memory 802 by the processor 801, thereby realizing various functions of the above-mentioned co-hosting device.

It should be noted that in this article, relational terms such as “first” and “second” are only used for distinguishing one entity or operation from another entity or operation, and do not necessarily require or imply any actual relationship or order between these entities or operations. Moreover, the terms “comprise”, “comprising”, or any other variation thereof are intended to encompass non-exclusive inclusions, so that a process, method, article, or device comprising a series of elements not only comprise those elements, but also other elements not explicitly listed, or elements inherent to such a process, method, article, or device. Without further limitation, an element defined by the statement “comprise a . . . ” does not exclude the existence of additional identical elements in the process, method, article, or device comprising the element.

The foregoing is only a detailed description of the disclosure to enable those skilled in the art to understand or implement the disclosure. Various modifications to these embodiments will be apparent to those skilled in the art, and the general principles defined herein may be implemented in other embodiments without departing from the spirit or scope of the disclosure. Accordingly, the disclosure will not be limited to the embodiments described herein, but will be subject to the widest scope consistent with the principles and novel features disclosed herein.

1. A co-hosting system, comprising a first co-hosting terminal, a second co-hosting terminal and a co-hosting business server;
the first co-hosting terminal being configured to: send a co-hosting application request to the second co-hosting terminal through the co-hosting business server;
the second co-hosting terminal being configured to: upon receipt of a co-hosting acceptance operation for the co-hosting application request, send a co-hosting acceptance message to the co-hosting business server, and apply to a real-time collaborative RTC server for joining a co-hosting room.

2. The system of claim 1, wherein,
the first co-hosting terminal is further configured to: upon receipt of the co-hosting acceptance message from the co-hosting business server, apply to the RTC server for joining the co-hosting room.

3. The system of claim 1, wherein,
the second co-hosting terminal is further configured to: upon receipt of the co-hosting acceptance operation for the co-hosting application request, present a countdown window.

4. The system of claim 3, wherein,
the second co-hosting terminal is further configured to: according to a determination that countdown of the countdown window ends, determine whether an audio-video stream pushed by the first co-hosting terminal has been received; and according to a determination that the audio-video stream has not been received, send a disconnecting co-hosting link request to the co-hosting business server and the RTC server respectively.

5. The system of claim 1, wherein,
the first co-hosting terminal is further configured to: upon receipt of the co-hosting acceptance message from the co-hosting business server, present a countdown window.

6. The system of claim 5, wherein,
the first co-hosting terminal is further configured to: according to a determination that countdown of the countdown window ends, push an audio-video stream to the RTC server.

7. The system of claim 1, wherein the first co-hosting terminal comprises a guest client, and the second co-hosting terminal comprises a host client.

8. A co-hosting method applied to a second co-hosting terminal, comprising:
receiving a co-hosting application request from a first co-hosting terminal through a co-hosting business server;
upon receipt of a co-hosting acceptance operation for the co-hosting application request, sending a co-hosting acceptance message to the co-hosting business server, and applying to a real-time collaborative RTC server for joining a co-hosting room.

9. The method of claim 8, wherein the method further comprises:
upon receipt of the co-hosting acceptance operation for the co-hosting application request, presenting a countdown window.

10. The method of claim 9, wherein the method further comprises:
according to a determination that countdown of the countdown window ends, determining whether an audio-video stream pushed by the first co-hosting terminal has been received; and according to a determination that the audio-video stream has not been received, sending a disconnecting co-hosting link request to the co-hosting business server and the RTC server, respectively.

11. A co-hosting method applied to a first co-hosting terminal, comprising:
sending a co-hosting application request to a second co-hosting terminal through a co-hosting business server; wherein the second co-hosting terminal is configured to: upon receipt of a co-hosting acceptance operation for the co-hosting application request, send a co-hosting acceptance message to the co-hosting business server, and apply to a real-time collaborative RTC server for joining a co-hosting room;
upon receipt of the co-hosting acceptance message from the co-hosting business server, applying to the RTC server for joining the co-hosting room.

12. The method of claim 11, wherein the method further comprises:
upon receipt of the co-hosting acceptance message from the co-hosting business server, presenting a countdown window.

13. The method of claim 12, wherein the method further comprises:
pushing an audio-video stream to the RTC server according to a determination that countdown of the countdown window ends.

14-15. (canceled)

16. A non-transitory computer-readable storage medium, wherein the computer-readable storage medium stores instructions that, when executed on a computer device, cause the computer device to implement the method of claim 8.

17. A device comprising: a memory, a processor, and a computer program stored on the memory, wherein the processor, when executing the computer program, implements the method of claim 8.

18. A computer program product, wherein the computer program product comprises a computer program/instructions, wherein the computer program/instructions, when executed by a processor, implements the method of claim 8.
